(19) United States
(12) Patent Application Publication
(10) Pub. No.: US 2004/0151304 A1
(43) Pub. Date: Aug. 5, 2004

(54) Method of managing power for devices requiring supply levels varying in accordance with operational state

(76) Inventors: Scott A. George, Austin, TX (US); Marius Goldenberg, Austin, TX (US)

Correspondence Address: DAVIS & ASSOCIATES, P.O. BOX 1093, DRIPPING SPRINGS, TX, 78620, US

(21) Appl. No.: 10/359,024

(22) Filed: Feb. 5, 2003

(51) Int. Cl. H04M 1/00; H04M 9/00

(52) U.S. Cl. 379/413; 379/399.01

(57) ABSTRACT

An apparatus for powering a plurality of devices sharing a supply line includes a supply control and a variable supply associated with the supply line. The supply control varies the supply level of the supply line to accommodate the supply level request representing a greatest magnitude supply level of any requests communicated from the devices. Another apparatus includes a plurality of supply controls each coupled to control a supply level provided by an associated supply line. Each device is capable of selectively coupling itself to an exclusive one of the supply lines. At least one device communicates a supply level request to a selected supply control that adjusts the supply level of its associated supply line to accommodate the supply level request representing the greatest supply level magnitude of any other supply level requests. If necessary, the selected device switches to the supply line associated with the selected supply control.

### FIELD OF THE INVENTION

This invention relates to methods and apparatus for managing power for devices requiring supply levels that may vary, for example, in accordance with device operational state. In particular, this invention is drawn to managing supply levels for power supplies that may be shared by a plurality of such devices.

### BACKGROUND OF THE INVENTION

A subscriber line interface circuit typically requires different power supply levels depending upon operational state. One supply level is required when the subscriber equipment is “on hook” and another supply level is required when the subscriber equipment is “off hook”. Yet another supply level is required for “ringing”.

In order to ensure sufficient supply levels, a power supply providing a constant or fixed supply level sufficient to meet or exceed the requirements of all of these states may be provided. Such a solution permits one or more SLICs to use a common power supply for at least two operational states.

One disadvantage of a shared fixed power supply architecture is that excess power is generated and must be dissipated as heat or otherwise wasted when a SLIC is not using a power supply level optimized for its particular operational state.

One alternative to sharing fixed power supplies is to provide a tracking power supply for each device. Each tracking power supply varies its supply level in accordance with the requirements of its associated device. This tracking power supply architecture is more power efficient than the shared fixed power supply architecture. Given that every device needs its own tracking power supply, however, the tracking power supply per device architecture is not economical for a large number of SLICs.

### SUMMARY OF THE INVENTION

Methods and apparatus for supplying power to a plurality of devices are described. One apparatus for providing power to a plurality of devices sharing a supply line includes a variable supply providing a supply level controlled by a supply control. The supply level varies to accommodate a selected supply level request communicated from the devices to the supply control. The magnitude of the supply level indicated by the selected request represents the maximum of the magnitudes of the supply levels indicated by any other supply level request.

Another embodiment includes a plurality of supply controls each controlling a supply level provided by an associated supply line. Each device can select any one of the supply lines. At least one selected device communicates a supply level request to a selected supply control. The selected supply control adjusts the supply level of its associated supply line to accommodate a selected request. The magnitude of the supply level indicated by the selected request represents the maximum of the magnitudes of the supply levels indicated by any other supply level request. If necessary, the selected device couples itself to the supply line associated with the selected supply control after decoupling itself from the supply line of another supply line control.

The supply level requests may be communicated at a pre-determined frequency regardless of the operational state of the device. Alternatively, the supply level requests may be communicated only in response to an anticipated change in operational state of the device. A supply control may be selected based on operational state, supply level, supply range, or other information.

In one application, the devices are subscriber line interface circuits (SLICs). In one embodiment, at least one supply control is disposed within a same integrated circuit package as at least one SLIC.

Other features and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of an apparatus for managing supply levels provided to one or more devices on a dedicated power supply per device approach.

FIG. 2 illustrates one embodiment of an apparatus for managing supply levels provided to one or more devices using one or more shared power supplies.

FIG. 3 illustrates one embodiment of a method of managing power supply levels for a plurality of devices.

FIG. 4 illustrates one embodiment of a method of managing power supply levels for a plurality of devices sharing a plurality of power supplies.

FIG. 5 illustrates one embodiment of a power supply apparatus for a plurality of subscriber line interface circuits.

FIG. 6 illustrates one embodiment of a method of managing voltage supply levels for a plurality of SLICs.

### DETAILED DESCRIPTION

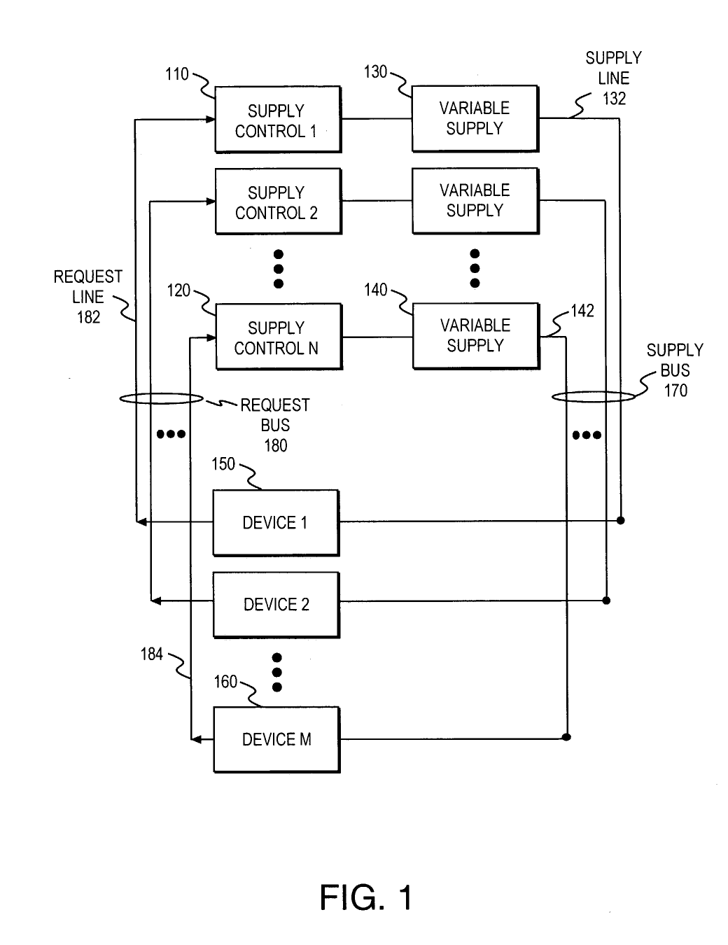

FIG. 1 illustrates one embodiment of an apparatus for managing power supplied to a plurality of devices 150-160. Each device has power requirements that vary in accordance with its operational state. Each device 150 has its own associated variable supply 130, supply line 132, and supply control 110. The supply controls 110-120 and associated variable supplies 130-140 form a power supply portion of the apparatus.

Each device issues supply level requests to its associated supply control 110 on a dedicated request line 182. The supply lines 132-142 are collectively referred to as the supply bus 170. Similarly, the request lines 182-184 are collectively referred to as the request bus 180. Each device 150 issues supply level requests on its associated request line 182. In response to the request, the corresponding supply control 110 adjusts its variable supply 130 to provide the requested supply level (i.e., voltage or current) on associated supply line 132.

The apparatus of FIG. 1 may be referred to as a per line dedicated dynamic tracking supply where each device has its own dedicated supply line and associated variable supply. Instead of a constant output, the variable supplies track the needs of the devices they are supplying. M devices 150-160 require M associated variable supplies 130-140 and supply controls 110-120 where M is a positive integer. Thus in this example, the number of variable supplies N must be the same as the number of devices M such that N=M.

The use of tracking power supplies tends to be more power efficient than providing fixed supply levels from which the devices may select from in accordance with operational state. This is particularly true if the number of fixed supply levels V is less than the number of substantially distinct supply levels S required by the various operational states. If V<S then at least one fixed supply level must be sufficient to accommodate the distinct requirements of multiple states resulting in wasted power for some operational states.

Another advantage of this arrangement is that supply levels can be adjusted to accommodate the specific operating environment of individual devices. One disadvantage of the per line dedicated supply approach is that scalability requires the number of variable supplies N to grow with the number of devices M.

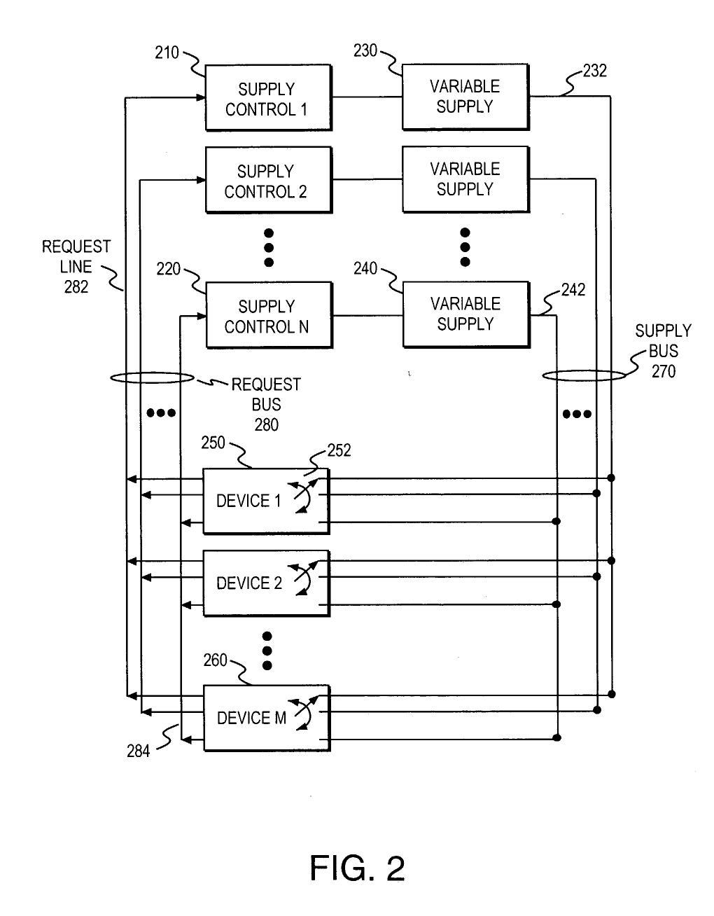

FIG. 2 illustrates an alternative power management apparatus. In this embodiment, a plurality of devices may concurrently share a common supply line and associated variable supply. When devices concurrently share a selected supply line, the supply level of the associated variable supply is adjusted to accommodate the device with the greatest magnitude of supply level requirements. This permits the supply levels to be managed in accordance with the supply requirements of the devices or constraints on the supplies such as supply levels, loading, power rating, etc., rather than being fixed.

Although “greatest supply level” implies the maximum supply level requirement, this is only true for positive power supply systems. Some power supply systems provide a negative supply, thus the variable supply would need to accommodate the most negative (i.e., minimum) of the requested supply levels. Selecting the supply level with the greatest magnitude or absolute value of all supply level requirements ensures that the proper supply level is chosen for either positive or negative supply systems.

Each supply control 210-220 has an associated request line 282-284. The request lines 282-284 collectively form a request bus 280. Unlike the request bus 180 of FIG. 1, however, every request line is shared with each of the devices 250-260. Thus each device 250-260 may communicate on any request line 282-284 of the request bus 280.

The supply lines 232-242 of the variable supplies 230-240 form a supply bus 270. Instead of a dedicating a supply line to each device, however, every device is capable of selecting one of the supply lines using a selector such as switch 252. Thus more than one device may receive its supply from the same variable supply. When one variable supply supports multiple devices, the variable supply must provide sufficient supply levels to accommodate the device with the greatest magnitude supply level requirement.

One advantage of the apparatus of FIG. 2 is that the number of power supplies N need not be the same as the number of devices M. Thus N may be greater than, less than, or the same as M.

In one embodiment, requests are communicated from the devices to supply controls continuously or with a pre-determined frequency independent of the state of the devices. Each device communicates a request to a specific supply control based on pre-determined configuration rules.

For example, specific variable supplies may be prioritized to provide the supply levels necessary for certain operational modes of the device as defined by the configuration rules. A device may designate a power supply for each of the operational states of the device, for example. In such a case, the operational state of the device determines which power supply is to be selected or designated.

In one embodiment, the devices are capable of sensing the supply levels provided by the power supplies. A device may designate a power supply based at least in part on the device operational state and the sensed supply levels.

In the event that the request bus supports bi-directional information, the devices may receive information from each power supply. Information such as current load, maximum power output, error conditions, etc. are parameters that may be communicated from the supply controls back to the devices use in determining which power supply to designate for a request.

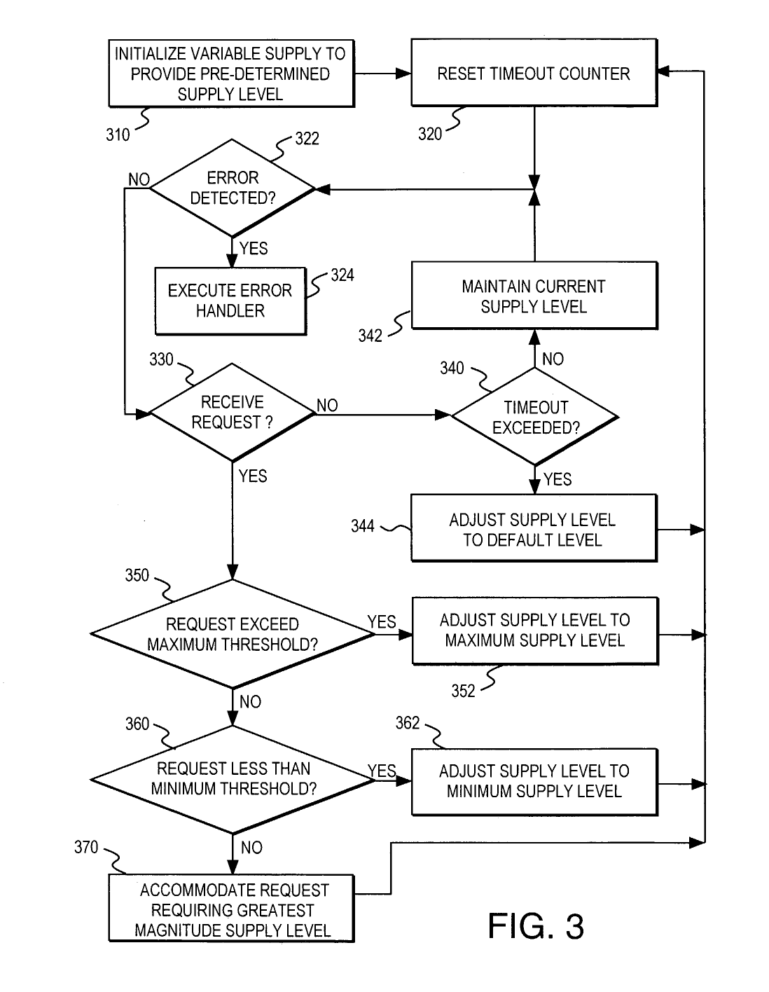

FIG. 3 illustrates one embodiment of a method of operating each power supply comprising a variable supply and supply control. In the illustrated embodiment, the method provides certain safeguards such as communication timeout limits, and upper and lower supply level limits.

In step 310, each variable supply is initialized to provide a pre-determined supply level (i.e., voltage or current). In step 320 a timeout counter is initialized.

Step 322 determines if any errors have been detected. If so, an error handler is executed in step 324. Examples of errors may include communication errors that prevent the power supply from properly communicating or responding to requests, or other errors that may be detected by the power supply or components external to the power supply. Steps performed by the error handler may include resetting the power supply or disabling the power supply. Depending upon type of error, the process may start over again or terminate after error handling.

If no errors have been detected and at least one request has been received as determined by step 330, then the requested supply level is compared with the maximum permitted supply level in step 350.

If the requested level exceeds the maximum supply level, then the supply level is set to the maximum supply level in step 352. If the requested level does not exceed the maximum supply level, then the requested level is compared to the minimum supply level in step 360. If the requested level is less than the minimum permitted supply level, then the supply level is set to the minimum supply level in step 362. If the requested level does not exceed the maximum or fall below the minimum levels, then the variable supply is adjusted to accommodate the request representing the greatest magnitude supply level of all the other requests in step 370.

After adjusting the supply level in steps 352, 362, or 370, the process returns to the step of resetting the timeout counter in step 320 and repeats.

If step 330 determines no requests have been received, step 340 determines if a timeout period has elapsed. This may be accomplished, for example, by comparing a clocked counter with a pre-determined timeout threshold or count. If the timeout threshold is exceeded, then the timeout period has been exceeded.

If the timeout period has not been exceeded, then the supply level is maintained at its current level as indicated by step 342. Processing then continues by returning to step 322.

If the timeout period has been exceeded, however, then the supply level is set to a default value in step 344. Processing then continues with resetting the timeout counter in step 320.

In one embodiment, the device provides an indicator in the event that a request exceeds the maximum, falls below the minimum, or has not been received within the timeout window. The device may subsequently utilize these indicator(s) to determine which power supply should be designated or selected for a subsequent request. Although illustrated separately from error handling, supply requests that are outside the range of acceptable minimum and maximum requests may simply be treated as errors to be handled by the error handler.

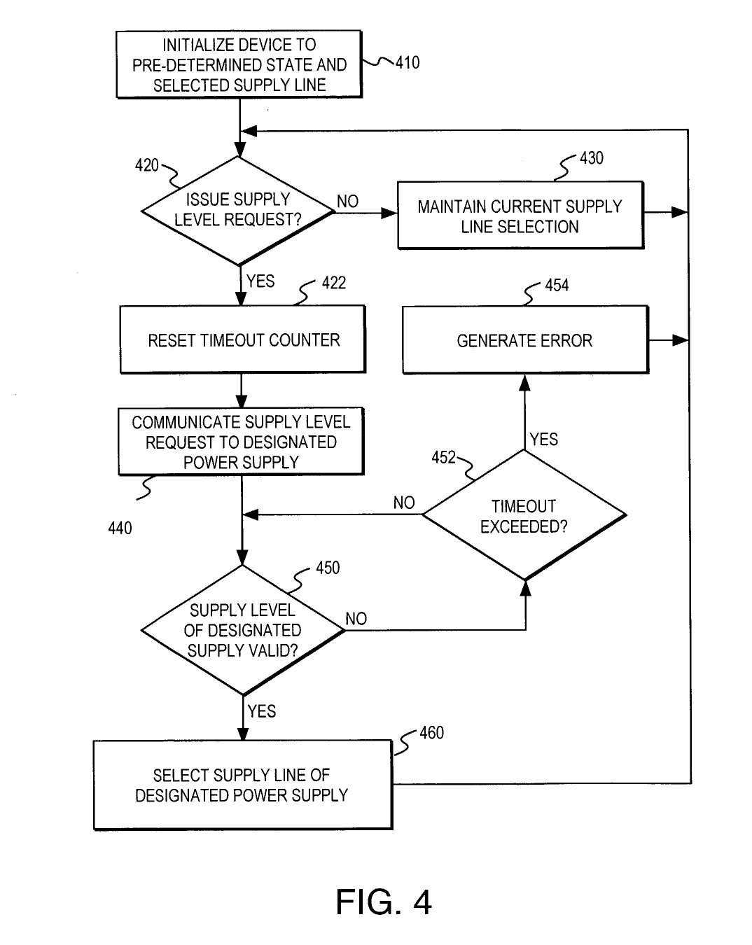

FIG. 4 illustrates one embodiment of a method of operating each device for efficient power management. In step 410, the selected device is initialized to a pre-determined state with a selected supply line.

In step 420, the device determines whether a supply level request should be issued. In one embodiment, the device periodically communicates supply level requests even if no change is needed. This ensures that power supplies are continuously updated with supply level requirements. In an alternative embodiment, the device only communicates requested supply levels when a supply level of increased magnitude is required (mandatory) or a supply level representing a significant decrease in magnitude than the magnitude of the current supply level is required (permissive). If the device does not need to issue a supply level request, the device may maintain its current supply line selection as indicated in step 430.

If a supply level request should be issued, the device resets a timeout counter in step 422. This timeout counter is used to allow the selected supply a pre-determined amount of time to accommodate the requested supply level. The device communicates any supply level request to the selected power supply in step 440.

The selected power supply should adjust as necessary to provide at least the supply level indicated by the request. In one embodiment, the devices are capable of sensing the supply level currently provided by any variable supply. Step 450 determines if the supply level provided by the selected supply is valid. In the event of a single device, the magnitude of the supply level provided must meet the magnitude of the supply requested. In the presence of multiple devices, the magnitude of the supply level provided must meet the requested supply level corresponding to the supply level request of the greatest magnitude.

In the event that the supply level is not valid, step 452 determines if a timeout period has elapsed. If so, then an error is generated in step 454 and processing continues with step 420. A timeout can indicate an overloaded power supply or a faulty power supply. Steps 450-452 are repeated until either the supply level is valid or the timeout period has elapsed.

In the event of a faulty supply, other components of the system (include the power supplies themselves) may subsequently disable the faulty supply or at least remove the power supplies identified as faulty from the list of power supplies eligible to be selected or designated for subsequent supply level requests.

If the supply level is valid the device selects the supply line associated with the selected power supply in step 460. The process then returns to step 420.

Referring to step 440, the device selects or designates a power supply based on a set of rules in one embodiment. A power supply may be designated for each of the operational states of the device, for example. In such a case, the operational state of the device determines which power supply is to be designated. In one embodiment, the range of the supply level request determines which power supply is to be designated.

In one embodiment, the devices are capable of sensing the supply levels provided by the power supplies. A power supply may be designated based at least in part on the device operational state and the sensed supply levels. If the request bus is bi-directional so that the power supplies may provide status information to the devices, the devices may use any such status information as one component of the decision making process for selecting a power supply. Examples of status information may include utilization factors, maximum output power, error codes, etc.

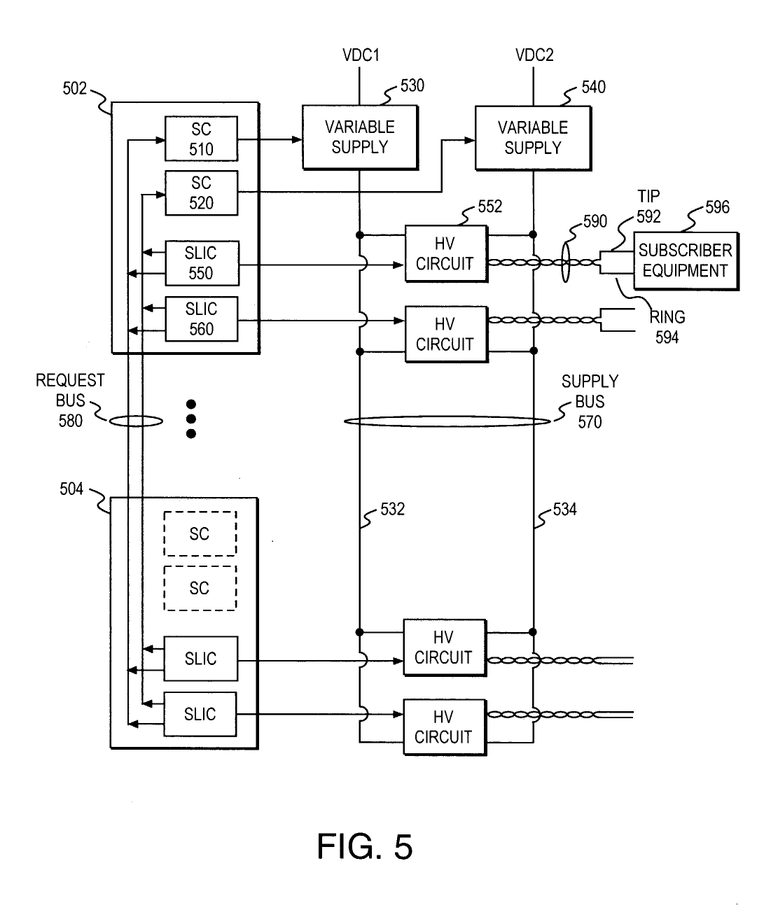

FIG. 5 illustrates a plurality of subscriber line interface circuits (SLICs) as devices for which the described methods and apparatus for power management may be applied. Subscriber line interface circuits are typically found in the central office exchange of a telecommunications network.

A subscriber line interface circuit (SLIC) provides a communications interface between the digital switching network portion of a telecommunications network and an analog subscriber line. The analog subscriber line connects to a subscriber station or telephone instrument at a location remote from the central office exchange. In the illustrated embodiment, tip 592 and ring 594 form the subscriber line 590. When subscriber equipment 596 is connected to the subscriber line, the subscriber line is referred to as a subscriber loop.

In the illustrated embodiment, at least a low voltage portion of two integrated circuit SLICs resides within each of K integrated circuit packages 502, for a total number of M SLICs (M=2•K). At least one integrated circuit package 502 includes a supply control 510. In the illustrated example, integrated circuit package 502 includes two supply controls, 510-520.

The integrated circuits can be fabricated as complementary metal oxide semiconductor (CMOS) integrated circuits. Although each of the K integrated circuit packages could be identical, cost efficiencies may be possible if at least some (504) of the integrated circuit packages do not include the supply controls.

If the K integrated circuit packages are identical and the number of distinct supply controls required (N) is less than the number of supply controls actually present, then the SLICs should be programmed to ensure that the excess supply controls cannot be designated targets of any supply level requests.

A request bus 580 communicates supply level requests from each of the SLICs to the plurality of supply controls 510-520. Each supply control 510 has an associated external variable supply 530. Each variable supply 530 has an associated supply line 532. The SLIC devices may select from any of the supply lines forming supply bus 570. Each SLIC 550 has an associated high voltage circuit 552 for selectively coupling the SLIC to an exclusive one of the supply lines 532-534.

In one embodiment, the supply controls are pulse width controllers for dc-to-dc converting power supplies 530-540. The supply levels provided by the variable supplies are used to drive the tip 592 and ring 594 lines of subscriber loop 590.

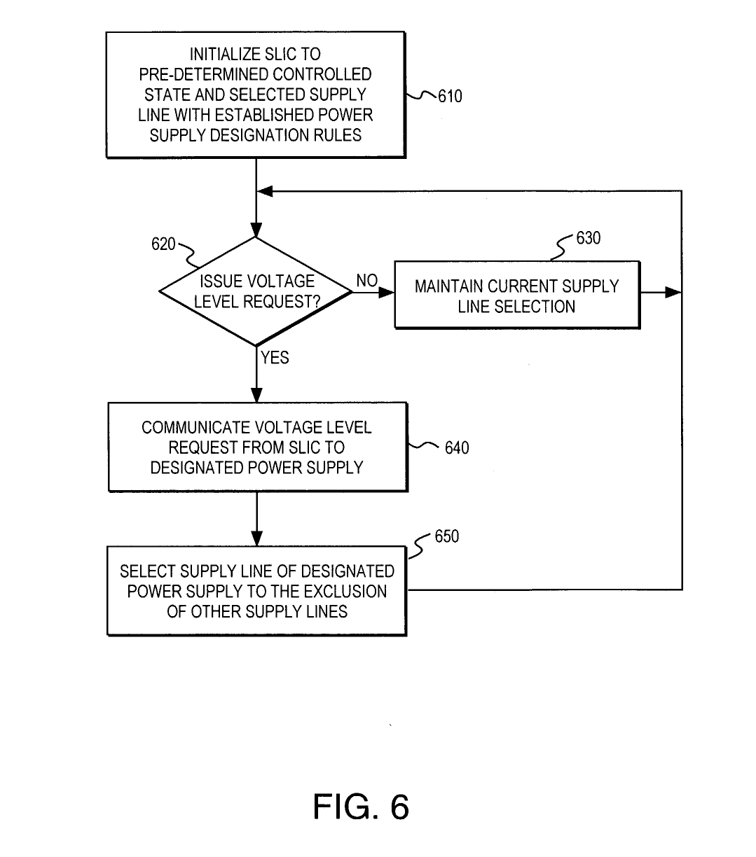

FIG. 6 illustrates one embodiment of a method of operating the SLIC devices of FIG. 5. The process is illustrated without any error condition checking safeguards so as not to obscure the invention.

In step 610, each SLIC is initialized to a pre-determined “controlled state” with a selected supply line. The “environmental state” of a SLIC is determined in part by the status of subscriber line equipment (such as a telephone) coupled to the subscriber loop. Manipulation of a telephone handset, for example, may alter the environmental state of a SLIC from “on-hook” to “off-hook”. The SLICs are also provided with supply controller designation rules in step 610.

The SLICs monitor the “environmental state” (e.g., current state of the attached subscriber equipment) as well as a “controlled state”. The controlled state should track the environmental state in the absence of problems with the subscriber loop or equipment. When the environmental state and controlled state are not the same, the environmental state represents the anticipated next controlled state or pending controlled state of the SLIC.

In step 620, the SLIC determines whether a voltage level request should be issued. In one embodiment, the SLIC periodically communicates voltage level requests even if no change is needed. This ensures that power supplies are continuously updated with voltage level requirements. In an alternative embodiment, the device only communicates requested voltage levels when the device requires a supply level having a greater magnitude than the supply level currently provided to the device or there is a significant change in required supply level (lower in magnitude) than what the device is currently receiving. If the device does not need to issue a voltage level request, the device may maintain its present supply line selection as indicated in step 630.

If the environmental state (e.g., “off hook”) represents an operational state distinct from the controlled state (e.g., “on hook”), then the SLIC should issue a voltage level request to accommodate the anticipated change in supply level requirements. Whether voltage level requests are initiated due to an anticipated change of controlled state or at a regular frequency independent of anticipated changes in controlled state, the voltage level request is communicated before the SLIC recognizes the environmental state as the new controlled state.

The SLIC communicates any voltage level request(s) to a selected power supply in step 640. The SLIC selects a power supply in accordance with a set of selection rules in one embodiment. A power supply may be designated for each of the operational states of the SLIC, for example. In such a case, the supply controller designation is determined by the environmental state of the SLIC and the designation rules. Alternatively, the power supply selection may be determined by ranges of voltage level requests, error conditions, power capacity, or other factors.

The designated power supply will adjust as necessary to provide at least magnitude and sign of the voltage level indicated by the request. The device then selects the supply line associated with the designated power supply in step 650. The process returns to step 620 to repeat itself.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of managing power supply levels comprises the steps of:
a) providing a supply control and a plurality of devices coupled to a supply line;
b) communicating at least one supply level request from the plurality of devices to the supply control; and
c) adjusting a supply level of the supply line to accommodate the supply level request representing a greatest supply level magnitude of all supply level requests.

2. The method of claim 1 wherein a required supply level of each device varies in accordance with an operational state of that device.

3. The method of claim 1 wherein the device is a subscriber line interface circuit.

4. The method of claim 1 wherein the supply control and at least a portion of one the plurality of devices resides within a same integrated circuit package.

5. A method of managing power supply levels comprises the steps of:
a) providing a plurality of selectable supply controls each coupled to control a supply level provided by an associated supply line;
b) communicating a supply level request from a device to a selected supply control; and
c) adjusting the supply level of the supply line associated with the selected supply control in accordance with the requested supply level.

6. The method of claim 5 further comprising the step of:
d) decoupling the device from a supply line distinct from the selected supply line; and
e) coupling the device to the selected supply line.

7. A method of managing power supply levels comprises the steps of:
a) providing a plurality of selectable supply controls each coupled to control a supply level provided by an associated supply line;
b) communicating a supply level request from at least one selected device of a plurality of devices to a selected supply control; and
c) adjusting the supply level of the supply line associated with the selected supply control to accommodate the supply level request representing the greatest supply level magnitude of all supply level requests communicated to the selected supply control.

8. The method of claim 7 further comprising the step of:
d) decoupling the selected device from a supply line distinct from the selected supply line; and
e) coupling the selected device to the selected supply line.

9. The method of claim 7 wherein selection of the selected supply control is determined in part by at least one of: an operational state of the device, a requested supply range that the supply level request indicates, a sensed supply level of the supply lines, a present load, and a maximum power output of the selected supply controller.

10. A power supply apparatus, comprising:
a supply control;
a variable supply and associated supply line, wherein a supply level provided by the supply line is controlled by the supply control; and
a plurality of devices coupled to the supply line, wherein at least one device communicates a supply level request to the supply control, wherein the supply control varies the supply level of the supply line to accommodate a supply level request representing the greatest supply level magnitude of supply level requests communicated to the supply control.

11. The apparatus of claim 10 wherein the devices are subscriber line interface circuits.

12. The apparatus of claim 10 wherein the supply control and at least a portion of one device are disposed within a same integrated circuit package.

13. The apparatus of claim 10 wherein the at least one devices issues supply level requests to the supply control at a pre-determined frequency.

14. The apparatus of claim 10 wherein the at least one devices issues supply level requests to the supply control only in response to an anticipated change in operational state.

15. A power supply apparatus, comprising:
a plurality of supply controls each coupled to control a supply level provided by an associated supply line; and
a plurality of devices coupled to the supply controls, each device capable of selective coupling to one of the supply lines, wherein at least one selected device communicates a supply level request to a selected supply control, wherein the selected supply control adjusts the supply level of its associated supply line to accommodate the supply level request representing the greatest magnitude supply level of all supply level requests communicated to the selected supply control.

16. The apparatus of claim 15 wherein each device further comprises:
a switch for selectively coupling the device to an exclusive one of the supply lines.

17. The apparatus of claim 16, wherein the device decouples itself from a supply line distinct from the selected supply line and couple itself to the selected supply line after communicating the supply level request.

18. The apparatus of claim 15 wherein at least one supply control and one device are disposed within a same integrated circuit package.

19. The apparatus of claim 15 wherein at least one device is at least a portion of a subscriber line interface circuit.

20. The apparatus of claim 15 wherein the number of devices (M) exceeds the number of supply controls (N) such that M>N.
